(19) United States
(12) Patent Application Publication
(10) Pub. No.: US 2022/0390092 A1
(43) Pub. Date: Dec. 8, 2022

(54) LIGHTING ASSEMBLY HAVING PRIMARY AND SECONDARY LIGHT SOURCES

(71) Applicant: Lee Schaak, Dix Hills, NY (US)

(72) Inventor: Lee Schaak, Dix Hills, NY (US)

(21) Appl. No.: 17/336,705

(22) Filed: Jun. 2, 2021

(51) Int. Cl. F21V 15/01; F21S 9/02; F21V 23/04

(52) U.S. Cl. CPC F21V 15/01; F21S 9/02; F21V 23/04; F21Y 2115/10

(57) ABSTRACT

A lighting assembly adapted for placement upon an article of furniture and/or securement to a wall, including a housing sub-assembly and an electronics sub-assembly, wherein the electronics sub-assembly includes an energy source, a circuit board, a mode switching component; and a primary light source and a secondary light source, wherein the primary light source includes an infinity LED, and the secondary light source includes a non-infinity LED which cooperatively provide a distinctive, marquee imagery.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to lighting assemblies, and, more particularly, to lighting assemblies adapted for placement upon an article of furniture or securement to a wall having a primary light source (e.g., an infinity light emitting diode (LED)) and a secondary light source (e.g., a non-infinity LED). The lighting assemblies of the present invention preferably operate in at least four modes, namely: (1) an off mode; (2) a primary light source mode; (3) a secondary light source mode; and (4) a dual, primary and secondary light source mode. The lighting assemblies of the present invention provide novel functionality and distinctive, marquee imagery.

### 2. Background Art

Lighting assemblies have been known in the art for years and are the subject of a plurality of patents and publications, including: U.S. Pat. No. 10,161,605 entitled “Lighting Assembly,” U.S. Pat. No. 9,759,391 entitled “LED Light Fixture Assembly,” U.S. Pat. No. 8,956,013 entitled “LED Light Troffer/Fixture Assembly,” U.S. Pat. No. 8,628,209 entitled “Light Assembly,” U.S. Pat. No. 7,847,486 entitled “LED Lighting System,” U.S. Pat. No. 6,979,097 entitled “Modular Ambient Lighting System,” United States Patent Application Publication Number 2013/0099698 entitled “Lighting Device,” United States Patent Application Publication Number 2013/0033195 entitled “Light Source Apparatus,” United States Patent Application Publication Number 2011/0163672 entitled “Light Assembly,” and Spanish Patent Application Publication Number 2,796,563 entitled “Lighting Device”—all of which are hereby incorporated herein by reference in their entirety including all references cited therein.

U.S. Pat. No. 10,161,605 appears to disclose an elongate tubular lighting assembly having a body with a length between spaced first and second ends. The tubular lighting assembly has a source of illumination and first and second connectors respectively at the first and second body ends. The first connector has cooperating first and second parts having first and second surfaces. The first and second connector parts are configured so that the first and second surfaces are placed in confronting relationship to prevent separation of the first and second connector parts with the body in an operative state as an incident of the first connector part moving relative to the second connector part from a position fully separated from the second connector part in a substantially straight path that is transverse to the length of the body into an engaged position.

U.S. Pat. No. 9,759,391 appears to disclose a light assembly that contains a housing. One or more LED light units are contained within the housing, wherein each of the LED light units may contain only one corresponding conductive end cap. A pair of conductors extending from each of the corresponding conductive end caps are mated with a corresponding socket contained within a DC power supply module contained within the housing.

U.S. Pat. No. 8,956,013 appears to disclose a light assembly that contains a troffer having a housing. One or more LED light units are contained within the troffer, wherein each one of the LED light units contains only one corresponding conductive end cap. A pair of conductors extending from each of the corresponding conductive end caps are mated with a corresponding socket contained within a DC power supply module contained within the troffer.

U.S. Pat. No. 8,628,209 appears to disclose a light assembly that includes a housing containing at least one solid-state lighting device. The solid-state lighting device electrically communicates with an AC energy source in a known manner. At least one photovoltaic cell is connected to an inner wall of the housing adjacent to the solid-state lighting device whereby the photovoltaic cell absorbs radiative energy from the solid-state lighting device. At least one battery pack derives energy from the artificial light of the lighting device, by and through the photovoltaic cell. One or more LED lights, or an LED array, are contained within the housing, and electronically communicate with the battery pack. An actuation sensor activates a switching means to energize the LED light(s) with DC power from the battery pack.

U.S. Pat. No. 7,847,486 appears to disclose a lighting system that has an array of at least one light-emitting solid-state element such as a light-emitting diode (LED) or a laser diode. A voltage source, which may supply either alternating or direct current, energizes the array. Array state circuitry, electrically connected in series with the array, senses at least one state of the array, such as the amount of current passing through the array, or temperature. Secondary circuitry is connected in parallel with the array. A switching component that adjusts the current passing through the secondary circuitry in accordance with the sensed state of the array such that current through the array is maintained substantially constant. A third, parallel, excess current shunt path may also be provided, in which case so is excess current shunt circuitry, which senses current flowing in the secondary circuitry and shunts current in the secondary circuitry in excess of an excess current threshold to the excess current shunt path, whereby overflow current above a first threshold for the array is shunted away from the array and excess current above a second threshold is shunted from the secondary circuits to the excess current shunt circuitry. A wide-angle mounting arrangement is also provided for the array.

U.S. Pat. No. 6,979,097 appears to disclose a modular ambient lighting system for providing lighting to the interior of a building. The system features three separate modules: (1) a support module, (2) a power module, and (3) a light fixture body module. The support module provides an electrical connection to the building and structural connection to the ceiling of the building. An interchangeable power module fits into a recess or “foot print” in the support module. The power module includes the electrical components of the lighting system (e.g., ballast, transformer, emergency batteries, etcetera). An interchangeable light fixture body module houses the lamp that can be configured to deliver direct, indirect, or direct/indirect illumination. The interchangeable features of the modules offer superior flexibility because of the ease to reconfigure the electrical operation of the light system, the type illumination delivered, or the aesthetics of the light system.

United States Patent Application Publication Number 2013/0099698 appears to disclose a light film apparatus having an illuminated graphics panel with at least two segments that can be individually powered. A controller manages a power which is delivered from a power supply to each of the segments, so that each of the segments is either powered on, powered off or powered to an intermediate level. With the independent control of power to the different segments, it is possible to create a three-dimensional appearance of a moving image from a generally two-dimensional panel arrangement. A housing can be mounted so that the graphics panel abuts or is closely mounted to a mounting surface.

United States Patent Application Publication Number 2013/0033195 appears to disclose a light source apparatus that includes at least a light-emitting module. The light-emitting module includes a hollow rod-shaped base and a plurality of LED chips. The hollow rod-shaped base has an outer surface and an inner surface opposite to the outer surface, in which the inner surface surrounds a space. The LED chips are disposed in flip chip bonding way on the outer surface of the hollow rod-shaped base, in which the LED chips are disposed surrounding the space.

United States Patent Application Publication Number 2011/0163672 appears to disclose an LED lighting assembly containing: a housing; one or more solid state lighting units contained within the housing and actuated by alternating current power; a night light contained within the housing and operably communicating with the solid state lighting units, the night light actuated by direct current power in the absence of light from the solid state lighting units; one or more light emitting diodes contained within the night light; and a battery source for powering the night light in the event of power interruption. The '672 reference appears to further disclose a lighting unit containing: a housing or elongated tube; one or more light emitting diodes contained within the housing or elongated tube; and a battery source contained within the housing or elongated tube, the battery source is configured to selectively power the light emitting diodes with direct current energy.

Spanish Patent Application Publication Number 2,796,563 appears to disclose an illumination device comprising a housing, a base, a solid-state light source, and an optical means, wherein the solid-state light source is optically coupled to the optical medium, where the optical medium is an element within the lighting device separate from and not integrated in the envelope, where the optical medium is provided with a light decoupling surface that allows the light to be decoupled from the optical medium by means of a roughness of the optical medium surface, characterized in that the optical medium comprises an optical fiber, where the surface roughness is provided along the fiber so that the emission along the fiber resembles the emission from a carbon filament lamp.

While the above-identified patents and publications do appear to disclose various lighting assemblies, their configurations remain non-desirous and/or problematic inasmuch as, among other things, none of the above-identified lighting assemblies are adapted for placement upon an article of furniture or securement to a wall having a primary light source (e.g., an infinity light emitting diode (LED)) combined with a secondary light source (e.g., a non-infinity LED). The prior art is also devoid of novel functionality and distinctive, marquee imagery provided by the lighting assemblies of the present invention.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention is directed to a lighting assembly adapted for placement upon an article of furniture and/or securement to a wall, comprising, consisting essentially of, and/or consisting of: (1) a housing sub-assembly, wherein the housing sub-assembly comprises: (a) at least one sidewall having an inner surface and an outer surface; (b) a top wall having an inner surface and an outer surface; (c) a bottom wall having an inner surface and an outer surface; and (d) wherein the at least one sidewall, the top wall, and the bottom wall are in a spaced-apart relationship to define an internal chamber therebetween; (2) an electronics sub-assembly, wherein the electronics sub-assembly comprises: (a) an energy source; (b) a circuit board; (c) a mode switching component; and (d) a primary light source and a secondary light source, wherein the primary light source comprises an infinity LED, and the secondary light source comprises a non-infinity LED which cooperatively provide a distinctive, marquee imagery.

In a preferred embodiment of the present invention, the lighting assembly operates in four distinct modes, wherein in a first mode the primary light source and the secondary light source are off, wherein in a second mode the primary light source is on and the secondary light source is off, wherein in a third mode the primary light source is off and the secondary light source is on, and wherein in a fourth mode the primary light source and the secondary light source are on.

In another preferred embodiment of the present invention, the at least one sidewall of the housing sub-assembly comprises a front sidewall, a rear sidewall, a left sidewall, and a right sidewall.

In yet another preferred embodiment of the present invention, the housing sub-assembly comprises the geometry of at least one of a cube, a cuboid, a tetrahedron, a pyramid, a square pyramid, a hexagonal pyramid, a prism, a triangular prism, a pentagonal prism, a hexagonal prism, an octahedron, a dodecahedron, an icosahedron, a cylinder, a cone, a polygon, a sphere, and an ellipsoid.

In one preferred embodiment of the present invention, the energy source of the electronics sub-assembly comprises at least one of an AC power supply, a DC power supply, an AC-DC power supply, a primary electrochemical cell, a secondary electrochemical cell, and a fuel cell.

In a preferred embodiment of the present invention, the circuit board of the electronics sub-assembly comprises at least one of a battery, a bridge rectifier, a capacitor, a central processing unit, a communications port, a control board, a crystal, a diode, a fuse, a graphics board, an inductor, an input port, an integrated circuit, a microprocessor, a memory module, an oscillator, an output port, a potentiometer, a receiver, a relay, a resistor, a semiconductor, a transformer, a transistor, a tuner, a video processing unit, a wired communications hub, and a wireless communications hub.

In another preferred embodiment of the present invention, the mode switching component comprises at least one of a pushbutton switch, a toggle switch, a selector switch, a proximity switch, a pressure switch, a conductivity switch, and a tactile sensor/switch.

In yet another preferred embodiment of the present invention, the mode switching component is associated with at least one of the at least one sidewall, the top wall, and the bottom wall of the containment sub-assembly.

In accordance with a preferred embodiment of the present invention, the primary light source comprises an infinity LED comprising: a first substantially transparent substrate having an outer surface and an inner surface; a second substrate having an outer surface and an inner surface, wherein a reflective material is associated with at least one of the outer surface and the inner surface; wherein the first substrate and the second substrate are in a spaced-apart relationship to define an infinity chamber therebetween; and at least one light-emitting diode associated with the infinity chamber.

In a preferred embodiment of the present invention, the secondary light source comprises at least one of a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb, and an electroconductive, lightable paint/material.

In another preferred embodiment of the present invention, the energy source is at least partially contained within the internal chamber of the housing sub-assembly, and wherein the energy source is in electrical communication with at least one of the circuit board, the primary light source, and the secondary light source.

In yet another preferred embodiment of the present invention, the circuit board is at least partially contained within the internal chamber of the housing sub-assembly, and wherein the circuit board is in electrical communication with at least one of the energy source, the primary light source, the secondary light source, and the mode switching component.

In one preferred embodiment of the present invention, the primary light source and the secondary light source are positioned above the housing sub-assembly, and wherein the primary light source and the secondary light source are in electrical communication with at least one of the energy source and the circuit board.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 of the drawings is a perspective view of a lighting assembly, in accordance with the present invention, showing a containment sub-assembly or housing and a representation of an electronics sub-assembly;

FIG. 2 of the drawings is an exploded perspective view of a lighting assembly, in accordance with the present invention, showing a containment sub-assembly or housing and a representation of an electronics sub-assembly;

FIG. 3 of the drawings is a perspective view of a lighting assembly, in accordance with the present invention, shown in a first position (off);

FIG. 4 of the drawings is a perspective view of a lighting assembly, in accordance with the present invention, shown in a second position (infinity LED only or primary light source);

FIG. 5 of the drawings is a perspective view of a lighting assembly, in accordance with the present invention, shown in a third position (non-infinity LED only or secondary light source);

FIG. 6 of the drawings is a perspective view of a lighting assembly, in accordance with the present invention, shown in a fourth position (both infinity LED and non-infinity LED on);

FIG. 7 of the drawings is schematic representation of an electronics sub-assembly for use in accordance with the present invention; and

FIG. 8 of the drawings is a cross-sectional schematic representation of an infinity LED or primary light source fabricated in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

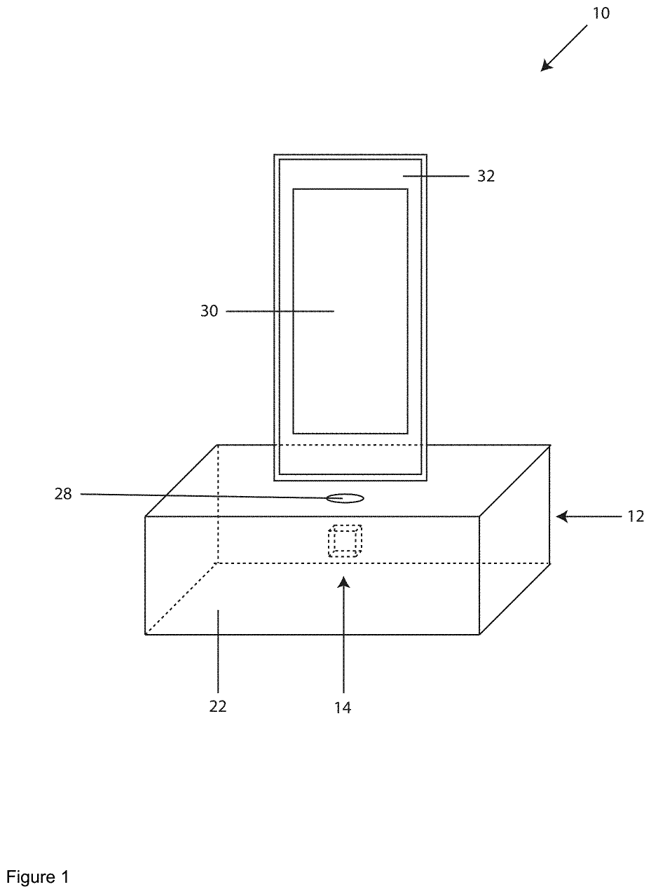

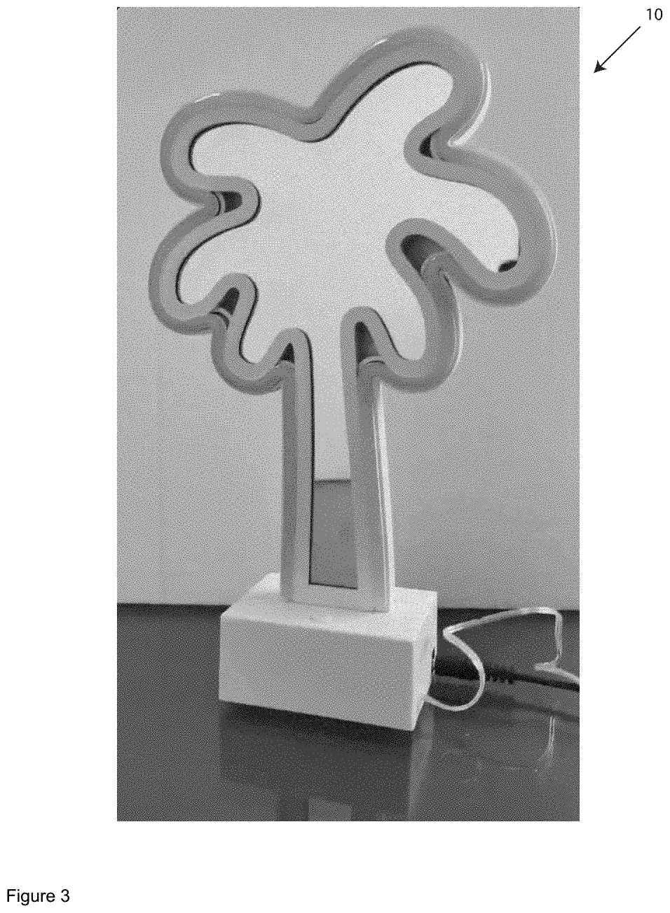

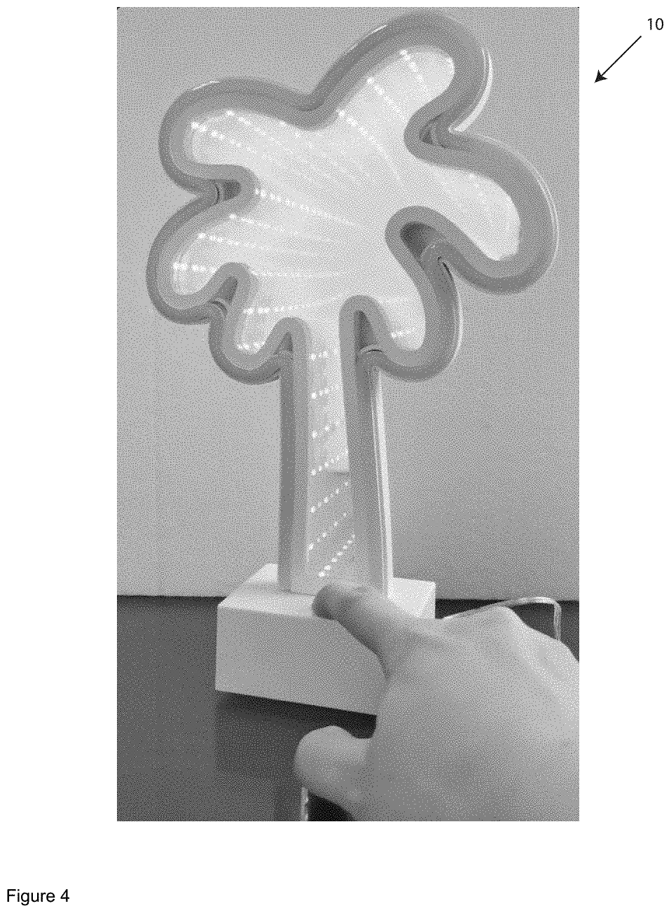

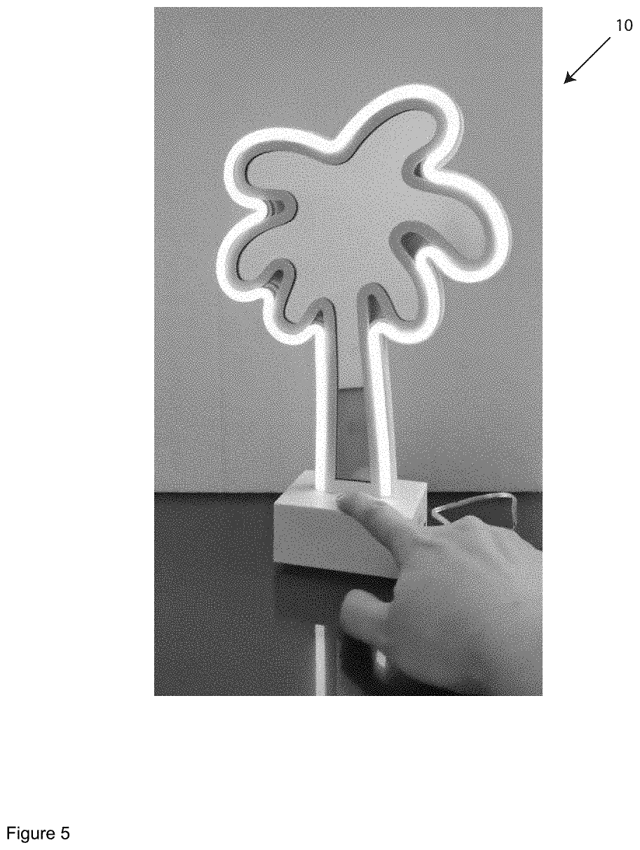

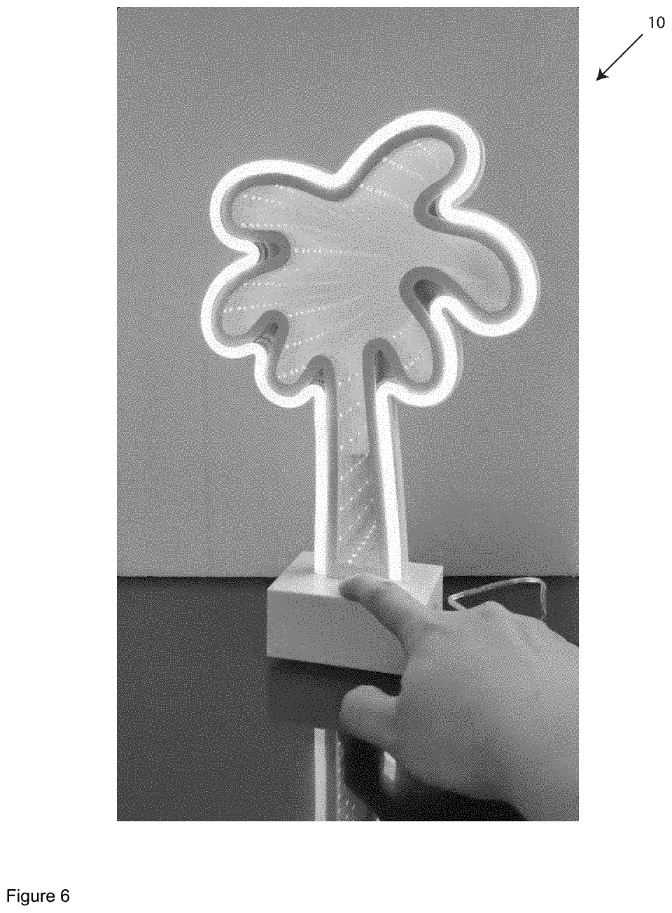

Referring now to the drawings, and to FIGS. 1-6 in particular, lighting assembly 10 is shown as generally comprising containment or housing sub-assembly 12 and electronics sub-assembly 14. Lighting assembly 10 is preferably adapted for placement upon an article of furniture (e.g., desk, dresser, nightstand, table, etcetera) and/or securement to a wall. The lighting assemblies of the present invention utilize light sources that cooperatively provide a distinctive, marquee-type imagery. The lighting assemblies of the present invention preferably utilize four distinct modes, namely: a first mode where the primary light source and the secondary light source are off (FIG. 3), a second mode where the primary light source is on and the secondary light source is off (FIG. 4), a third mode where the primary light source is off and the secondary light source is on (FIG. 5), and a fourth mode where the primary light source is on and the secondary light source is on (FIG. 6).

Housing/containment sub-assembly 12 preferably comprises one or more sidewalls 16 having inner surfaces and outer surfaces, top wall 18 having an inner surface and an outer surface, and bottom wall 20 having an inner surface and an outer surface. Sidewalls 16, top wall 18 and bottom wall 20 are preferably spaced-apart from each other to define an internal chamber 22 therebetween.

In accordance with the present invention, housing/containment sub-assembly 12 preferably comprises a body fabricated from a metal, a metal alloy, a natural resin, a synthetic resin, a plastic, a composite, wood, and/or combinations thereof.

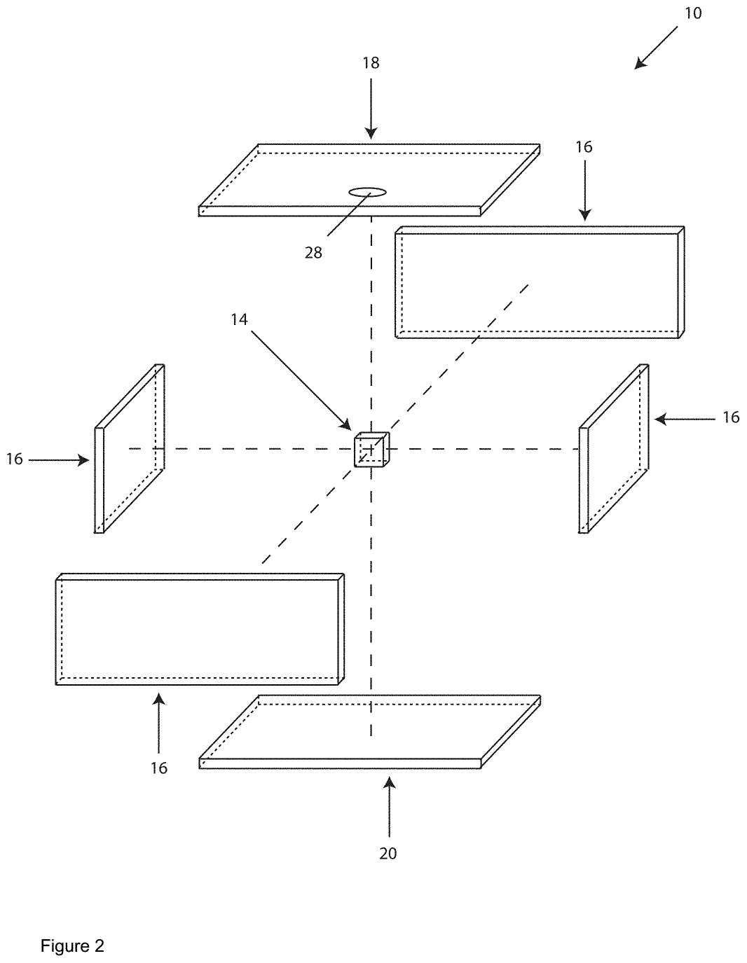

Referring now to FIGS. 2-6, containment sub-assembly 12 preferably includes a front sidewall, a rear sidewall, a left sidewall, and a right sidewall.

In accordance with the present invention, containment sub-assembly 12 preferably comprises the general geometry of a cube, a cuboid, a tetrahedron, a pyramid, a square pyramid, a hexagonal pyramid, a prism, a triangular prism, a pentagonal prism, a hexagonal prism, an octahedron, a dodecahedron, an icosahedron, a cylinder, a cone, a sphere, a polygon, and/or an ellipsoid.

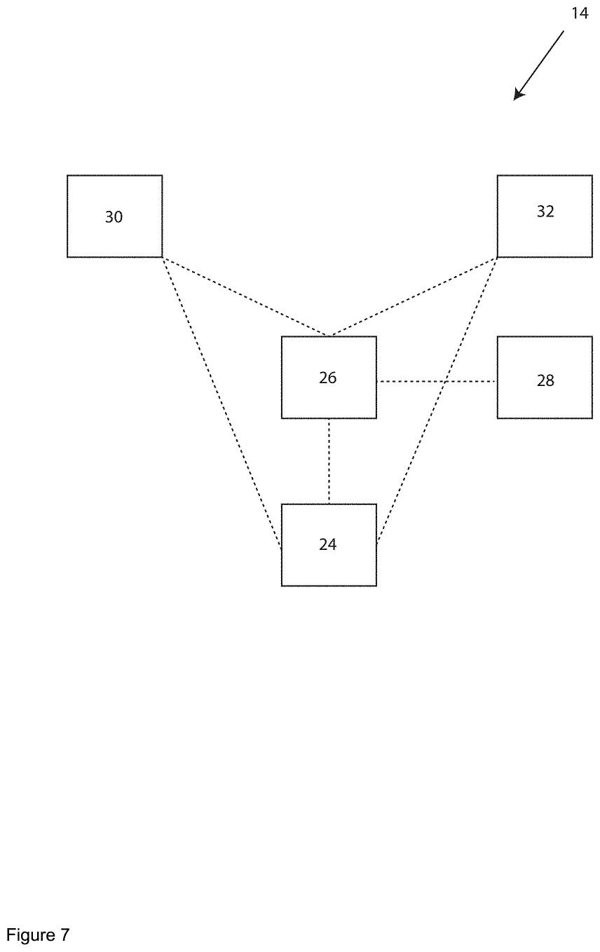

Referring now to FIG. 7, electronics sub-assembly 14 of lighting assembly 10 generally comprises energy source 24, circuit board/controller (e.g., printed circuit board) 26, mode switching component 28, primary light source 30, and secondary light source 32.

Energy source 24 is preferably at least partially contained within internal chamber 22 of containment sub-assembly 12. Energy source 24 is also preferably in electrical communication with circuit board 26 and/or light sources 30, 32. Energy source 24 of the electronics sub-assembly preferably comprises, for example, an AC power supply, a DC power supply, an AC-DC power supply, a primary electrochemical cell, a secondary electrochemical cell, and/or a fuel cell.

Circuit board/controller 26 is preferably at least partially contained within internal chamber 22 of containment sub-assembly 12. Circuit board/controller 26 is preferably in electrical communication with energy source 24, mode switching component 28, and light sources 30, 32.

In a preferred embodiment of the present invention, circuit board/controller 26 of electronics sub-assembly 14 comprises one or more components, such as a battery, a bridge rectifier, a capacitor, a central processing unit, a communications port, a control board, a crystal, a diode, a fuse, a graphics board, an inductor, an input port, an integrated circuit, a microprocessor, a memory module, an oscillator, an output port, a potentiometer, a receiver, a relay, a resistor, a semiconductor, a switch, a transformer, a transistor, a tuner, a video processing unit, a wired communications hub, and/or a wireless communications hub.

Mode switching component 28 is preferably associated with at least one of the sidewalls, the top wall, and the bottom wall of the containment assembly. Mode switching component 28 is preferably in electrical communication with circuit board/controller 26. In one embodiment of the present invention, mode switching component 28 comprises at least one of a pushbutton switch, a toggle switch, a selector switch, a proximity switch, a pressure switch, a conductivity switch, and a tactile sensor/switch.

Primary light source 30 of electronics sub-assembly 14 is preferably positioned at least partially above internal chamber 22 of containment sub-assembly 12. Primary light source 30 is preferably in electrical communication with energy source 24 and/or circuit board/controller 26.

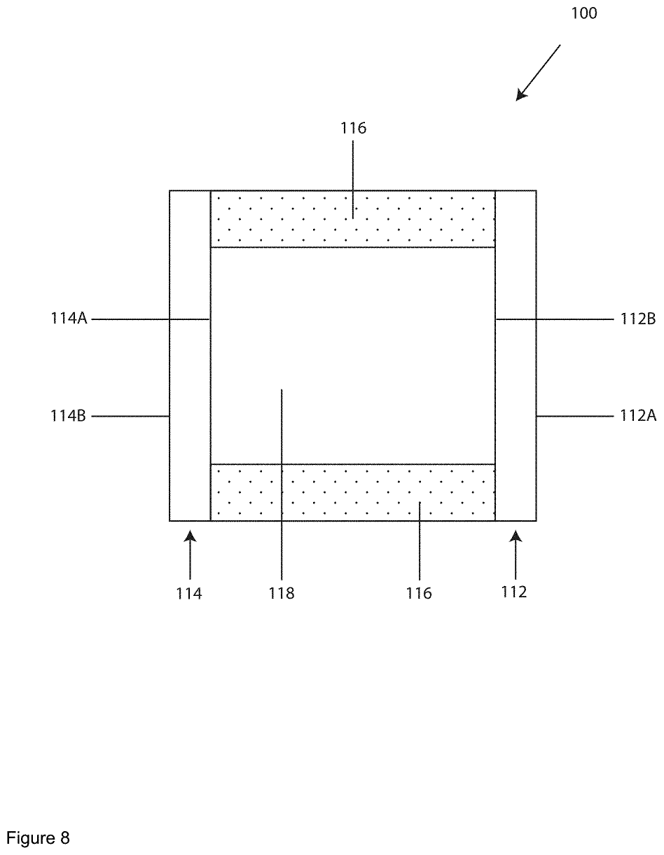

In one embodiment of the present invention, primary light source 30 comprises infinity-type LED sub-assembly 100. As is best shown in FIG. 8, and in this embodiment, LED sub-assembly 100 generally comprises first transparent substrate 112 having front surface 112A and rear surface 112B, second substrate 114 having front surface 114A and rear surface 114B, and one or more light-emitting diodes 116. Substrates 112 and 114 are preferably maintained in a generally parallel, spaced-apart manner to define infinity chamber 118 positioned therebetween.

Transparent substrate 112 may be fabricated from any material that is transparent and has sufficient strength to be able to operate in the environmental conditions to which the assembly will be exposed. Substrate 112 may comprise any type of borosilicate glass, soda lime glass, float glass, or any one of a number of other materials, such as, for example, MYLAR®, polyvinylidene chloride, polyvinylidene halides, such as polyvinylidene fluoride, a polymer or plastic, such as cyclic olefin copolymers like Topas® available from Ticona, LLC of Summitt, N.J., that is transparent in the visible region of the electromagnetic spectrum. While particular substrate materials have been disclosed, for illustrative purposes only, it will be understood that numerous other substrate materials are likewise contemplated for use—so long as the materials are at least substantially transparent and exhibit appropriate physical properties, such as strength, to be able to operate effectively in conditions of intended use. Indeed, lighting assemblies of the present invention can be, during normal operation, exposed to extreme temperature variation, as well as substantial UV radiation, emanating primarily from the sun.

Second substrate 114 will also have sufficient strength and be able to operate in the environmental conditions to which the device will be exposed. Second substrate 114 includes a reflective material (e.g., biaxially-oriented polyethylene terephthalate, metals, transition metals, Ag, Au, Al, etcetera) associated with and/or deposited on one or both of surfaces 114A and 114B. Preferably, the reflective material provides a reflectivity of greater than approximately 80%, more preferably greater than approximately 90%, and yet more preferably greater than approximately 99.9%. It will be understood that first and/or second substrates 112 and 114, respectively, can optionally be tempered, heat strengthened, and/or chemically strengthened, prior to or subsequent to being coated with one or more layers of reflective material. First substrate 112 and second substrate 114 are preferably fabricated from a sheet of glass having a thickness ranging from approximately 0.5 millimeters (mm) to approximately 12.7 mm, and more preferably less than approximately 1.0 mm for certain low weight applications.

Additionally, substrates 112 and 114 may be treated or coated as is described in U.S. Pat. No. 6,239,898 entitled “Electrochromic Structures,” U.S. Pat. No. 6,193,378 entitled “Electrochromic Device Having A Self-Cleaning Hydrophilic Coating,” and U.S. Pat. No. 6,816,297 entitled “Electrochromic Mirror Having A Self-Cleaning Hydrophilic Coating,” the disclosures of which are hereby incorporated herein by reference in their entirety. Other treatments, such as anti-reflectance coatings, hydrophilic coatings, low-E coatings, and UV-blocking layers are also contemplated for use in accordance with the present invention. It will be understood that such coatings may be associated with substrates 112 and/or 114 in this as well as other embodiments.

Light-emitting diodes 116 when positioned in chamber 118, provide an effect of the lights repeating essentially indefinitely from the foreground to the background of mirrored primary light source 30.

In accordance with the present invention, light-emitting diodes 116, and, in turn, primary light source 30 preferably comprises one or more light-emitting diodes, one or more organic light-emitting diodes, and/or one or more tri-color (RGB) light-emitting diodes.

Secondary light source 32 is preferably configured to surround at least a portion of the primary light source. In one embodiment, the secondary light source is positioned external to the entire outer peripheral boundary/geometry of the primary light source. In this embodiment the secondary light source serves as a lighted frame for the primary light source.

In accordance with the present invention, secondary light source 32 of electronics sub-assembly 14 preferably comprises a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb and/or an electroconductive, lightable paint and/or material.

In another embodiment of the present invention, electronics sub-assembly 14 further comprises one or more of a secondary energy source, a secondary light source, a secondary user interface, a secondary circuit board, a secondary speaker, a vibration mechanism, a white noise generator, a thermo sensor, a tactile sensor, and/or a display—all of which are preferably in electrical communication with circuit board/controller 26. Preferably, the display is adapted to display at least one of alpha-numeric content, temperature, time, image and/or graphic.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A lighting assembly adapted for placement upon an article of furniture and/or securement to a wall, comprising:
a housing sub-assembly, wherein the housing sub-assembly comprises:
at least one sidewall having an inner surface and an outer surface;
a top wall having an inner surface and an outer surface;
a bottom wall having an inner surface and an outer surface; and
wherein the at least one sidewall, the top wall, and the bottom wall are in a spaced-apart relationship to define an internal chamber therebetween;
an electronics sub-assembly associated with the housing sub-assembly, wherein the electronics sub-assembly comprises:
an energy source;
a circuit board;
a mode switching component; and
a primary light source and a secondary light source, wherein the primary light source comprises an infinity LED, and the secondary light source comprises a non-infinity LED which cooperatively provide a distinctive, marquee imagery, wherein the circuit board is positioned below the primary light source and the secondary light source, and wherein at least a portion of the primary light source and the secondary light source, is positioned above the outer surface of the top wall of the housing sub-assembly.

2. The lighting assembly according to claim 1, wherein when in a first mode the primary light source and the secondary light source are off, wherein when in a second mode the primary light source is on and the secondary light source is off, wherein when in a third mode the primary light source is off and the secondary light source is on, and wherein when in a fourth mode the primary light source is on and the secondary light source is on.

3. The lighting assembly according to claim 1, wherein the at least one sidewall of the housing sub-assembly comprises a front sidewall, a rear sidewall, a left sidewall, and a right sidewall.

4. The lighting assembly according to claim 1, wherein the housing sub-assembly comprises the geometry of at least one of a cube, a cuboid, a tetrahedron, a pyramid, a square pyramid, a hexagonal pyramid, a prism, a triangular prism, a pentagonal prism, a hexagonal prism, an octahedron, a dodecahedron, an icosahedron, a cylinder, a cone, a polygon, a sphere, and an ellipsoid.

5. The lighting assembly according to claim 1, wherein the energy source of the electronics sub-assembly comprises at least one of an AC power supply, a DC power supply, an AC-DC power supply, a primary electrochemical cell, a secondary electrochemical cell, and a fuel cell.

6. The lighting assembly according to claim 1, wherein the circuit board of the electronics sub-assembly comprises at least one of a battery, a bridge rectifier, a capacitor, a central processing unit, a communications port, a control board, a crystal, a diode, a fuse, a graphics board, an inductor, an input port, an integrated circuit, a microprocessor, a memory module, an oscillator, an output port, a potentiometer, a receiver, a relay, a resistor, a semiconductor, a transformer, a transistor, a tuner, a video processing unit, a wired communications hub, and a wireless communications hub.

7. The lighting assembly according to claim 1, wherein the mode switching component comprises at least one of a pushbutton switch, a toggle switch, a selector switch, a proximity switch, a pressure switch, a conductivity switch, and a tactile sensor/switch.

8. The lighting assembly according to claim 7, wherein the mode switching component is associated with at least one of the at least one sidewall, the top wall, and the bottom wall of the containment sub-assembly.

9. The lighting assembly according to claim 1, wherein the primary light source comprises an infinity LED comprising:
a first substantially transparent substrate having an outer surface and an inner surface;
a second substrate having an outer surface and an inner surface, wherein a reflective material is associated with at least one of the outer surface and the inner surface;
wherein the first substrate and the second substrate are in a spaced-apart relationship to define an infinity chamber therebetween; and
at least one light-emitting diode associated with the infinity chamber.

10. The lighting assembly according to claim 1, wherein the secondary light source comprises at least one of a light-emitting diode, an organic light-emitting diode, a tri-color (RGB) light-emitting diode, an incandescent bulb, a tungsten-halogen bulb, a xenon bulb, a fluorescent bulb, a compact fluorescent lamp, a high-intensity discharge bulb, and an electroconductive, lightable paint/material.

11. The lighting assembly according to claim 1, wherein the energy source is at least partially contained within the internal chamber of the housing sub-assembly, and wherein the energy source is in electrical communication with at least one of the circuit board, the primary light source, and the secondary light source.

12. The lighting assembly according to claim 1, wherein the circuit board is at least partially contained within the internal chamber of the housing sub-assembly, and wherein the circuit board is in electrical communication with at least one of the energy source, the primary light source, the secondary light source, and the mode switching component.

13. The lighting assembly according to claim 1, wherein the primary light source and the secondary light source are positioned above the housing sub-assembly, and wherein the primary light source and the secondary light source are in electrical communication with at least one of the energy source and the circuit board.

14. A lighting assembly adapted for placement upon an article of furniture and/or securement to a wall, comprising:
a housing sub-assembly, wherein the housing sub-assembly comprises:
at least one sidewall having an inner surface and an outer surface;
a top wall having an inner surface and an outer surface;
a bottom wall having an inner surface and an outer surface; and
wherein the at least one sidewall, the top wall, and the bottom wall are in a spaced-apart relationship to define an internal chamber therebetween;
an electronics sub-assembly associated with the housing sub-assembly, wherein the electronics sub-assembly comprises:
an energy source;
a circuit board;
a mode switching component; and
a primary light source and a secondary light source, wherein the primary light source comprises an LED comprising: a first substantially transparent substrate having an outer surface and an inner surface; a second substrate having an outer surface and an inner surface, wherein a reflective material is associated with at least one of the outer surface and the inner surface; wherein the first substrate and the second substrate are in a spaced-apart relationship to define an infinity chamber therebetween; and at least one light-emitting diode associated with the infinity chamber, wherein the circuit board is positioned below the primary light source and the secondary light source, and wherein at least a portion of the infinity chamber is positioned above the outer surface of the top wall of the housing sub-assembly; and
wherein when in a first mode the primary light source and the secondary light source are off, wherein when in a second mode the primary light source is on and the secondary light source is off, wherein when in a third mode the primary light source is off and the secondary light source is on, and wherein when in a fourth mode the primary light source is on and the secondary light source is on.
